(19) United States
(12) Patent Application Publication
(10) Pub. No.: US 2009/0076185 A1
(43) Pub. Date: Mar. 19, 2009

(54) Method for the preparation of a transparent thermosetting polymer / thermoplastic polymer blend type material and its use in optics for the manufacture of organic glasses

(75) Inventors: Fabien Berit-Debat, Charenton Le Pont (FR); Noemie Lesartre, Charenton Le Pont (FR)

Correspondence Address: OCCHIUTI ROHLICEK & TSAO, LLP, 10 FAWCETT STREET, CAMBRIDGE, MA, 02138, US

(73) Assignee: Essilor International (Compangnie Generale D'Optique), Charenton le Pont (FR)

(21) Appl. No.: 12/197,630

(22) Filed: Aug. 25, 2008

(30) Foreign Application Priority Data
Aug. 29, 2007 (FR) 0706056

(51) Int. Cl. C08F 2/46; C08L 53/02

(52) U.S. Cl. 522/181; 525/94; 264/1.1

(57) ABSTRACT

The present invention relates to a method for the preparation of a transparent moulding comprising a blend of a thermoset polymeric material forming the matrix of said article, and a thermoplastic polymeric material, dispersed within said thermoset polymeric material, said process comprising at least the following stages:
i) preparation of a liquid polymerizable mixture by dissolving said thermoplastic polymeric material in a thermosetting composition that is a precursor of said matrix,
ii) filling of a mould with the liquid polymerizable mixture prepared in stage i),
iii) polymerization of the liquid polymerizable mixture until a hardened blend of polymers is obtained, and
iv) removal of the moulding formed by said blend of polymers,
   said process being characterized by the fact that the thermosetting composition comprises at least 60% by weight of 4,4′-di(ethoxyethyl)-bisphenol A dimethacrylate and at least 12% by weight of at least one monofunctional or multifunctional acrylic comonomer and by the fact that the thermoplastic polymeric material comprises at least one polystyrene-block-polybutadiene-block-poly(methyl methacrylate) (PS-b-PB-b-PMMA) triblock copolymer.

The invention also relates to a transparent moulding obtained by this method as well as the polymerizable liquid mixture prepared in stage i).

The present invention relates to a polymerizable liquid mixture of a particular thermoset polymeric material and a particular thermoplastic polymeric material that modifies the mechanical and/or optical properties of the thermoset polymeric material, the thermoset polymeric material generally constituting the main phase of the polymerizable liquid mixture, as well as a method for cast moulding of said blend making it possible to obtain a transparent article. The invention also relates to a transparent article obtained by this process, more particularly an ophthalmic lens.

There are two types of substrates generally used for the manufacture of optical articles, for example ophthalmic lenses, namely mineral glass substrates and organic glass substrates. Currently, the market is tending to develop very largely in favour of organic glasses which have two major advantages over mineral glasses: their good impact-resistance and their lightness. The most-used organic glass substrates are bisphenol A polycarbonate and that obtained by polymerization of diethylene glycol bis(allyl carbonate), sold under the trade name CR 39® by the company PPG INDUSTRIES (ESSILOR ORMA® lens).

Although a certain number of transparent organic substrates which are known to be generally satisfactory already exist, it is still desirable to have available other types of polymerizable compositions allowing novel transparent substrates to be obtained, leading to optical articles combining useful properties such as good resistance to impact, crack propagation and solvents.

It is known that a particular dimethacrylic monomer, namely 4,4′-di(ethoxyethyl)-bisphenol A dimethacrylate of formula (I)

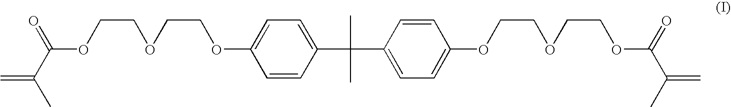

produces, after polymerization/crosslinking, a transparent material the impact resistance and crack-propagation resistance of which it would be useful to improve. The purpose of the present invention is thus to improve the mechanical properties, in particular the impact resistance and crack-propagation resistance, without loss of the modulus of elasticity, of such a thermoset poly(meth)acrylic system without however significantly reducing the transparency of the latter.

It is known to incorporate thermoplastic copolymers, and in particular sequenced thermoplastic copolymers, in small quantities into thermosetting polymer systems in order to improve the mechanical properties of the latter.

In the field of transparent organic glasses, there may be mentioned the following examples of incorporation of sequenced polymers into thermosetting systems:

In particular, the incorporation of triblock copolymers of the type styrene-(1,4-butadiene)-methylmethacrylate-(SBM copolymers of the ABC type) from the company Arkema into thermosetting epoxy matrices has given rise to recent studies and has led to spectacular results in terms of improvement of the mechanical properties of the materials which, moreover, retain their transparency and suffer only a slight reduction in the modulus of elasticity. These works are described, for example, in the article “A new class of Epoxy Thermosets”, Girard-Reydet, E.; Pascault, J. P.; Bonnet, A.; Court, F.; Leibler, L. Macromol. Symp. 2003, 198, 309-322, and in the patent application EP 1290088, which describes more particularly block copolymers.

During tests on the improvement of the mechanical properties of a thermosetting polymer system based on 4,4′-di(ethoxyethyl)-bisphenol A dimethacrylate (formula (I) above) by incorporation of polystyrene-block-polybutadiene-block-poly(methyl methacrylate) triblock thermoplastic copolymers, the applicant was confronted with the problem of a demixing of the thermoplastic phase during the stage of crosslinking the thermosetting material. The thermoplastic copolymer, initially soluble in the thermosetting monomer, becomes progressively incompatible with the system as a highly crosslinked three-dimensional network is formed. The copolymer thus “expelled” from the system during hardening is found in the final material in the form of microdomains dispersed in the thermoset matrix, microdomains which, when they exceed a certain size, are visible to the naked eye and result in a more or less significant reduction in the transparency of the material which prevents its use for the manufacture of optical articles.

The applicant has succeeded in solving this problem and obtaining blends of transparent polymers based on 4,4′-di(ethoxyethyl)-bisphenol A dimethacrylate, and on triblock copolymers, by adding to the dimethacrylic monomer a small quantity of a monofunctional or multifunctional acrylic comonomer, the latter being preferably chosen from methyl methacrylate and hydroxyethyl methacrylate or a mixture thereof.

Thus, when a triblock thermoplastic copolymer of the type polystyrene-block-polybutadiene-block-poly(methyl methacrylate) is dissolved in 4,4′-di(ethoxyethyl)-bisphenol A dimethacrylate mixed with a relatively small quantity of one of the monofunctional or multifunctional acrylic comonomers, and this homogeneous system is subjected to polymerization, the demixing of the thermoplastic copolymer is greatly reduced and the final thermoset material is made up of a thermoset matrix in which nanodomains of thermoplastic polymer are dispersed, in other words nanometric domains invisible to the eye which do not alter the transparency of the material.

The subject of the present invention is therefore a method for the preparation of a transparent moulding comprising a blend of a thermoset polymeric material forming the matrix of said moulding and of a thermoplastic polymeric material, dispersed within said thermoset polymeric material, said method comprising at least the following stages:

i) preparation of a liquid polymerizable mixture by dissolving said thermoplastic polymeric material in a thermosetting composition that is a precursor of said matrix,

ii) filling of a mould with the liquid polymerizable mixture prepared in stage i),

iii) polymerization of the liquid polymerizable mixture until a hardened blend of polymers is obtained, and

iv) removal of the moulding formed by said blend of polymers, said process being characterized by the fact that the thermosetting composition comprises at least 60% by weight, preferably between 70 and 85% by weight of 4,4′-di(ethoxyethyl)-bisphenol A dimethacrylate of formula (I)

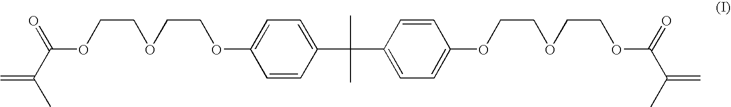

and at least 12% by weight, preferably 15% to 30% by weight, of at least one monofunctional or multifunctional acrylic comonomer and by the fact that the thermoplastic polymeric material comprises at least one polystyrene-block-polybutadiene-block-poly(methyl methacrylate) (PS-b-PB-b-PMMA) triblock copolymer.

The monofunctional acrylic comonomer is chosen from isobornyl acrylate (IBOA), tetrahydrofurfuryl acrylate (THFA), lauryl acrylate and 2-phenoxyethyl acrylate (PEA), methyl methacrylate (MMA) and hydroxyethyl methacrylate (HEMA).

In the case of a multifunctional acrylic comonomer the latter is chosen from difunctional acrylic comonomers such as 1,6-hexanediol diacrylate (HDDA), tricyclodecanedimethanol diacrylate (TCDDMDA), diethylene glycol diacrylate (DEGDA), polyethylene glycol diacrylate, tetraethylene glycol diacrylate, triethylene glycol diacrylate, tripropylene glycol diacrylate, polyethylene glycol diacrylate, dipropylene glycol diacrylate, alkoxylated hexanediol diacrylate, esterdiol diacrylate, polypropylene glycol diacrylate and neopentyl glycol propoxyl diacrylate, or the multifunctional acrylic comonomers chosen from trimethylolpropane ethoxyl triacrylate (TMPEOTA), pentaerythritol tetraacrylate (PETTA), trimethylol-propane triacrylate (TMPTA), ditrimethylolpropane tetraacrylate (Di-TMPTTA), tris(2-hydroxyethyl)-isocyanurate triacrylate (THEICTA), dipentaerythritol pentaacrylate (DiPEPA), pentaerythritol triacrylate, 3-propoxylated trimethylolpropane triacrylate (TMPPOTA), 4-ethoxylated pentaerythritol tetraacrylate (PPTTA), 5-ethoxylated pentaerythritol triacrylate, 5-ethoxylated pentaerythritol tetraacrylate, and glycerol propoxyl triacrylate (GPTA).

In an advantageous fashion, a monofunctional acrylic comonomer is preferably used, and more particularly a comonomer chosen from methyl methacrylate (MMA) and hydroxyethyl methacrylate (HEMA), or a mixture thereof.

A blend of polymers, in the sense in which this term is used in the present invention, denotes a mixture of at least one thermoplastic polymer with at least one thermosetting polymer.

The adjective “thermosetting” or “thermoset” as used in the present application does not necessarily denote a system a system that is hardenable or hardened by application of heat. In fact, the hardening can take place at ambient temperature, or even at a temperature below ambient temperature, for example in the case of photopolymerization. This term is used in the present application, as in the field of plastics in general, as the opposite of the term “thermoplastic”. In other words, a thermoset polymer is a hard material, formed by a crosslinked three-dimensional macromolecular network, which does not become fluid at an elevated temperature.

As indicated above, the transparent moulding prepared by the method of the invention is constituted by a blend of polymers. It comprises a first thermoset polymeric material forming the matrix of the finished article, thermoset and dispersed in the form of nano-domains within said hardened polymer matrix, a second thermoplastic polymer phase formed by the triblock copolymer. The thermoset phase formed by the first material is generally the main phase.

The transparent moulding is prepared, according to the invention, by polymerization of a liquid polymerizable mixture, comprising a thermosetting polymerizable composition (precursor of the thermoset matrix) in which the triblock thermoplastic polymer is dissolved, the hardening of said thermosetting polymerizable composition forming the first thermoset material.

The thermosetting composition preferably represents 80 to 97% by weight, in particular 90 to 95% by weight of the mass of the polymerizable liquid mixture. The thermoplastic polymeric material preferably represents 3 to 20% by weight, in particular 5 to 10% by weight of the polymerizable liquid mixture.

The polymerization of the polymerizable mixture according to the invention can be of radical, anionic or cationic type or be carried out by metathesis by ring-opening in the presence of cyclo-olefins, techniques that are well known to a person skilled in the art. In the case where the polymerizable mixture according to the invention contains polymerizable monomers bearing ethylene groups, the initiation of the polymerization and the polymerization are generally carried out under irradiation. This may be photopolymerization, optionally in the presence of a polymerization initiator, or irradiation by means of a beam of electrons (electron beam irradiation), a type of polymerization which does not require the presence of a polymerization initiator since the energy of the electron beam is sufficient to create the free radicals required for polymerization. The polymerizable mixture according to the invention can also be polymerized using a combination of these methods. Preferably, the thermosetting polymerizable composition of the invention comprises at least one polymerization initiator, preferably at least one photoinitiator.

According to a particularly preferred embodiment, the thermosetting polymerizable composition of the invention is polymerized by photopolymerization and comprises at least one photoinitiator, the latter preferably representing 0.1% to 10% of the mass of the thermosetting polymerizable composition.

Among the photoinitiators that can be used for the purposes of the invention in the thermosetting polymerizable composition, there may be mentioned, without limitation, the aromatic α-hydroxy-ketones, α-amino-ketones, benzophenones, acetophenones, benzyldimethylketals, monoacylphosphine oxides (MAPO), bisacylphosphine oxides (BAPO), tertiary amine/diketone mixtures, alkylbenzoylethers, benzoin ethers, phenyl glyoxylates, thioxanthones and cationic photoinitiators such as triaryl sulphonium salts and aryliodonium salts.

There may be mentioned in particular the photoinitiators marketed by the company Ciba Specialty Chemicals under the general designation IRGACURE®, in particular the photoinitiator IRGACURE® 184 (1-hydroxycyclohexyl-phenylketone), the photoinitiator IRGACURE® 500 which is a 50/50 by mass mixture of 1-hydroxycyclohexyl-phenylketone and benzophenone, the photoinitiator IRGACURE® 651 (2,2-dimethoxy-2-phenyl-acetophenone), the photoinitiator IRGACURE® 819 (bis(2,4,6-trimethylbenzoyl)-phenylphosphine oxide), the photoinitiator IRGACURE® 907 (2-methyl-1-[4-(methylthio)-phenyl]-2-morpholino-propan-1-one), the photoinitiator IRGACURE® 1700 (25/75 by mass mixture of bis(2,6-dimethoxybenzoyl)-2,4-4-trimethylpentyl-phosphine oxide and DAROCUR® 1173), the photoinitiators marketed by the company Ciba Specialty Chemicals under the general designation DAROCUR®, in particular the photoinitiator DAROCUR® 1173 (2-hydroxy-2-methyl-1-pheny1-propan-1-one), the photoinitiator DAROCUR® TPO (2,4,6-trimethylbenzoyl-diphenylphosphine oxide), the photoinitiator DAROCUR® 4265 (50/50 by mass mixture of DAROCUR® 1173 and DAROCUR® TPO), the photoinitiator marketed by the company Ciba Specialty Chemicals under the designation CGI 1850, which is a 50/50 by mass mixture of IRGACURE® 184 and bis(2,6-dimethoxybenzoyl)-2,4-4-trimethylpentyl-phosphine oxide, the photoinitiators marketed by the company BASF under the general designation Lucirin®, in particular the photoinitiator Lucirin® TPO-L (ethyl 2,4,6-trimethylbenzoylphenyl phosphinate), bis(2,6-dimethoxybenzoyl)-2,4-4-trimethylpentyl-phosphine oxide, benzophenone, 2,4,6-trimethyl benzophenone, 4-methyl benzophenone, 2,2-dimethoxy-2-phenyl-acetophenone, 2,2-diethoxy-acetophenone (DEAP, marketed by Upjohn), 4-(2-hydroxyethoxy)phenyl-(2-hydroxy-2-methylpropyl) ketone, 2-benzyl-2-N,N-dimethylamino-1-(4-morpholinophenyl)-butan-1-one.

The preferred photoinitiator is CGI 1850, corresponding to formula (IV):

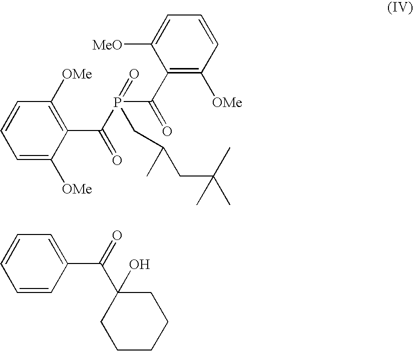

The polymerization reaction is initiated using an appropriate means, namely visible light, UV radiation or any other means, the choice depending on the type of photoinitiator used.

The polymerization initiators can be used alone or mixed with hardness-modifying agents such as, for example, photosensitizers, accelerators (catalysts) or polymerization inhibitors, in conventional proportions. Certain photoinitiators can also have photosensitization properties.

Non-limiting examples of photosensitizers and accelerators that can be used in the present invention are thioxanthones such as ITX (2- or 4-isopropyl-thioxanthone) or chlorothioxanthones such as CPTX (1-chloro-4-propoxythioxanthone), quinones such as camphroquinone, benzanthrones, Michler's ketone (4,4′-bis(dimethylamino)-benzophenone), fluorenone, triphenyl acetophenone, dimethyl-ethanolamine, methyldiethanolamine, triethanolamine, DMPT (N,N-dimethyl-para-toluidine), MHPT (N-[2-hydroxyethyl]-N-methyl-para-toluidine), ODAB (octyl para-N,N-dimethylamino benzoate), EDAB (ethyl para-N,N-dimethylamino-benzoate, marketed by Aceto Corporation under the name Quantacure® EPD), EDMA (2-ethyl-9,10-dimethoxyanthracene or their mixtures. In particular, a camphroquinone/EDAB mixture can be used.

Non-limiting examples of polymerization inhibitors (inhibitors of free radicals) that can be used in the present invention are N-nitroso-N-phenylhydroxylamine ammonium salt, tris[N-nitroso-N-phenylhydroxylamine aluminium salt, 4-methoxyphenol (MEHQ), hydroquinone and substituted hydroquinones, pyrogallol, phenothiazine, 4-ethyl-catechol, sterically hindered amines and their mixtures.

The thermosetting polymerizable composition according to the invention can also comprise a certain number of other additives used conventionally in polymerizable compositions for optical articles, in particular ophthalmic lenses, in conventional proportions. Examples of additives are, without limitation, colorants, stabilizers such as UV absorbers, antioxidants and anti-yellowing agents, perfumes, deodorants, mould-release agents, lubricants, adhesion promoters and coupling agents.

Among the UV absorbers (systems that filter UV radiation) that can be used for the purposes of the invention in the thermosetting polymerizable composition, there may be mentioned, without limitation, 4-aminobenzoic acid (PABA) and its salts, anthranilic acid and its salts, salicylic acid and its salts or its esters, in particular aryl hydroxybenzoates, 4-hydroxycinnamic acid and its salts, sulphonic derivatives of benzoxazoles, benzimidazoles and benzothiazoles and their salts, benzophenones, in particular sulphonic derivatives of benzophenones and 2-hydroxybenzophenones and their salts, sulphonic derivatives of benzylidene camphor and their salts, derivatives of benzylidene camphor substituted with a quaternary ammonium group and their salts, phthalylidene derivatives of camphorsulphonic acid and their salts, benzotriazoles, in particular sulphonic derivatives of benzotriazole and their salts, oxalamides, oxanilides, and their mixtures thereof.

Non-limiting examples of UV absorbers that can be used in the present invention are 2-(2-hydroxyphenyl)-2H-benzotriazole, PBSA (sodium salt of 2-phenyl-benzimidazole-5-sulphonic acid, marketed under the name PARSOL® HS by Givaudan-Roure), 4-tert-butyl-4′-methoxy-dibenzoylmethane (marketed under the name PARSOL® 1789 by Givaudan-Roure), 2-ethylhexyl p-methoxycinnamate or avobenzone (marketed under the name PARSOL® MCX by Givaudan-Roure), octyl p-methoxycinnamate, UVINUL® MS 40 (2-hydroxy-4-methoxybenzophenone-5-sulphonic acid, BASF), UVINUL® M 40 (2-hydroxy-4-methoxybenzophenone, BASF), octocrylene (2-ethylhexyl 2-cyano-3,3-diphenylacrylate), 2-ethylhexyl 4-dimethylaminobenzoate (octyl dimethyl-PABA), triethanolamine salicylate, octyl salicylate. It is also possible to use polymers having UV photoprotection properties, in particular the polymers comprising benzylidene camphor and/or benzotriazole groups, substituted with sulpho or ammonium quaternary groups. They can be used alone or mixed with other UV absorbers.

Anti-yellowing agents such as those described in the patents U.S. Pat. No. 5,442,022, U.S. Pat. No. 5,445,828, U.S. Pat. No. 5,702,825, U.S. Pat. No. 5,741,831 and FR 2699541 can be used, without limitation, alone or mixed. The preferred anti-yellowing agent is 3-methyl-but-2-en-1-ol (M-BOL). In general, the mass of the anti-yellowing agents represents 0.5 to 4% of the mass of the thermosetting polymerizable composition according to the invention.

Among the antioxidants that can be used for the purposes of the invention in the thermosetting polymerizable composition, there may be mentioned, without limitation, the sterically hindered phenolic antioxidants, IRGANOX® 245 DW (ethylene bis(oxyethylene)bis-(3-(5-tert-butyl-4-hydroxy-m-tolyl)propionate) marketed by the company Ciba Specialty Chemicals.

The block polymers of the present invention are trisequenced copolymers, also called triblock copolymers, polystyrene-block-polybutadiene-block-poly(methyl methacrylate) (PS-b-PB-b-PMMA), hereafter called SBM copolymers.

The block copolymers that can be used within the framework of the invention are described in particular in the patent applications WO 2005/073314 and WO 2005/014699. Reference may be made in particular to these documents for a detailed description of the PS, PB and PMMA portions of these block copolymers.

Finally, it is important for the production of a transparent moulding comprising a blend of polymers, by the method of the invention, that the poly(methyl methacrylate) (PMMA) block of the block polymer represents a relatively large fraction of the block copolymer. According to an advantageous variant of the invention, the PMMA block preferably represents 50% to 80% by weight, more preferably 52% to 70% by weight, of the weight-average molar mass of the polystyrene-block-polybutadiene-block-poly(methyl methacrylate) block copolymer.

Thus, for a trisequenced SBM copolymer having a weight-average molar mass comprised between 15,000 and 200,000 g/mol, the weight-average molar mass of the poly(methyl methacrylate) block is preferably comprised between 10,000 and 100,000 g/mol,

Within the framework of the invention it is understood that the block copolymers used can be a mixture of triblock copolymers and diblock copolymers of the polystyrene-block-polybutadiene type.

The method of the invention comprises at least four stages. The first stage consists of preparing a mixture which can be polymerized by dissolving the triblock thermoplastic polymer in the thermosetting polymerizable composition. The thermoplastic polymer is preferably used in powder or granule form. It is generally added progressively and under stirring to the thermosetting polymerizable composition. If the dispersion obtained is not homogeneous at ambient temperature, it can be heated under stirring in a thermostated oil bath until the triblock copolymer is totally solubilized. By ambient temperature is meant in the present invention a temperature comprised between 15 and 25° C. This dissolution phase can take several weeks at a temperature of the order of 80° C. The polymerizable mixture obtained, generally transparent and viscous, can be filtered, optionally while hot, then degassed under stirring, optionally while hot, before being used in the second cast moulding stage.

This second stage involves filling a mould with the polymerizable mixture thus obtained. Optionally, said polymerizable mixture can be preheated, just like the mould. Generally, a temperature of the order of 80-90° C. is perfectly suitable. The polymerizable liquid mixture can for example be poured into an assembly constituted by two mineral glass mould parts held together by an adhesive strip around the periphery.

The third stage involves polymerizing the liquid polymerizable mixture until a hardened blend of polymers is obtained, preferably by photopolymerization. This polymerization is preferably carried out at a temperature comprised between 0° C. and 100° C., in particular at a temperature comprised between 10 and 30° C., and ideally at ambient temperature, i.e. at a temperature comprised between 20 and 25° C., until a material is obtained which is sufficiently hard to be removed from the mould and which has the sought mechanical and optical properties.

The polymerization is preferably left to take place until more than 90%, preferably more than 95%, of the acrylic double bonds initially present in the initial mixture have reacted.

Finally, in the fourth and last stage, the removal and recovery of the moulding are carried out.

The subject of the present invention is a transparent moulding comprising a blend of a thermoset polymer and of a triblock thermoplastic polymer, capable of being obtained by a method as described above.

The transparent mouldings obtained according to the method of the invention are preferably optical articles, i.e. organic glasses. They are intended, generally but not exclusively, for use as optical articles, preferably as ophthalmic lenses. They have the advantage of possessing mixed properties originating from each of the two materials, in particular good resistance to the solvents provided by the thermoset material and good resistance to impact and to crack propagation attributable to the thermoplastic polymeric material dispersed in the form of nano-domains in the thermoset matrix.

In order to improve other properties of such optical articles made of organic glass, such as for example abrasion and scratch resistance, anti-reflective character and smear resistance, it is possible to form one or more functional coatings on at least one of their principal surfaces.

A major drawback of organic glasses, which are less hard than mineral glasses, is in fact their low resistance to scratching. It is thus known to form successively, on a principal surface of the substrate, a first coating, called primary anti-impact coating, the purpose of which is to increase the impact resistance of the article and also the adhesion of subsequent coatings to the substrate then, on this primary anti-impact coating, a hard coating, generally called anti-abrasion or anti-scratch coating, the purpose of which is to improve the ability of the surface of the optical article to withstand damage due to mechanical stresses. The anti-abrasion coating will be covered with an anti-reflective coating, which in its turn will be covered with an anti-smear coating, whose role is to modify the interfacial tension between the anti-reflective layer and water or grease (in order to reduce their adherence), but also to block the interstices so as to prevent grease from infiltrating and remaining.

The subject of the present invention is also the starting polymerizable liquid mixture which is used for the implementation of the method according to the present invention and leads to the transparent moulding. This polymerizable liquid mixture comprises a thermoplastic polymeric material, chosen from the polystyrene-block-polybutadiene-block-poly(methyl methacrylate) triblock copolymers, dissolved in a thermosetting composition, comprising at least 60% by weight, preferably between 70 and 85% by weight of 4,4′-di(ethoxyethoxy)-bisphenol A dimethacrylate of formula (I)

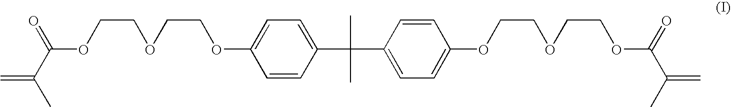

and at least 12% by weight, preferably 15% to 30% by weight, of at least one monofunctional or multifunctional acrylic comonomer.

The monofunctional acrylic comonomer is chosen from isobornyl acrylate (IBOA), tetrahydrofurfuryl acrylate (THFA), lauryl acrylate, 2-phenoxyethyl acrylate (PEA), methyl methacrylate (MMA) and hydroxyethyl methacrylate (HEMA).

In the case of a multifunctional acrylic comonomer the latter is chosen from the difunctional acrylic comonomers such as 1,6-hexanediol diacrylate (HDDA), tricyclodecanedimethanol diacrylate (TCDDMDA), diethylene glycol diacrylate (DEGDA), polyethylene glycol diacrylate, tetraethylene glycol diacrylate, triethylene glycol diacrylate, tripropylene glycol diacrylate, polyethylene glycol diacrylate, dipropylene glycol diacrylate, alkoxylated hexanediol diacrylate, esterdiol diacrylate, polypropylene glycol diacrylate and neopentyl glycol propoxyl diacrylate, or the multifunctional acrylic comonomers chosen from trimethylolpropane ethoxyl triacrylate (TMPEOTA), pentaerythritol tetraacrylate (PETTA), trimethylolpropane triacrylate (TMPTA), ditrimethylolpropane tetraacrylate (Di-TMPTTA), tris(2-hydroxyethyl)isocyanurate triacrylate (THEICTA), dipentaerythritol pentaacrylate (DiPEPA), pentaerythritol triacrylate, 3-propoxylated trimethylolpropane triacrylate (TMPPOTA), 4-ethoxylated pentaerythritol tetraacrylate (PPTTA), 5-ethoxylated pentaerythritol triacrylate, 5-ethoxylated pentaerythritol tetraacrylate, and glycerol propoxyl triacrylate (GPTA).

In an advantageous manner according to the invention, a monofunctional acrylic comonomer is preferably used, and more particularly chosen from methyl methacrylate (MMA) and hydroxyethyl methacrylate (HEMA), or a mixture thereof.

All of the previously specified preferences involving in particular relative proportions of the thermosetting composition and the thermoplastic polymeric material, the nature and the quantity of the polymerization initiator, the chemical nature and the molar mass of the thermoplastic polymer are of course also applicable to the polymerizable liquid mixture.

### EXAMPLES

The different thermosetting polymerizable compositions used are prepared by mixing a basic “formulation A” with variable proportions of a monofunctional acrylic comonomer according to the invention, namely methyl methacrylate (MMA) or hydroxyethyl methacrylate (HEMA).

The basic formulation A is constituted by:
98 mass-% of a dimethacrylate of formula (I),

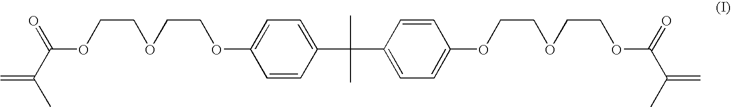

1.8 mass-% of 3-methyl-but-2-en-1-ol (M-BOL, anti-yellowing agent), and
0.2 mass-% of CGI 1850 [photoinitiator of formula (IV)],
the percentages being expressed relative to the total mass of the polymerizable thermosetting composition,

The triblock copolymer used in this example is a PS-b-PB-b-PMMA of average molar mass by weight of 41 900 g/mol containing a fraction by mass of the PMMA block greater than 50%.

The triblock copolymer is introduced slowly in the form of powder into the thermosetting composition (formulation A+methyl methacrylate or hydroxyethyl methacrylate or isobutyl methacrylate) heated beforehand to a temperature of 80° C. The suspension is maintained at this temperature and under stirring throughout the duration of the dissolution phase which lasts approximately 7 days.

The polymerizable mixture obtained is transparent and viscous (viscosity: approximately 10 Pa·s at ambient temperature).

The polymerizable liquid mixture is then filtered through a filter with a pore size of 20 microns. After degassing the filtered polymerizable mixture for 2 hours, approximately 30 mL of mixture is removed in a syringe preheated for approximately 30 minutes at 80° C. and injected into an assembly constituted by two mould parts made of mineral glass held by an adhesive strip around the periphery, also preheated to 80° C.

The moulds thus filled are then stored for 10 hours at a temperature of approximately 20° C. After this rest period at ambient temperature, the polymerization is initiated by exposure to ultraviolet radiation. After an exposure period of approximately 13 minutes a transparent organic glass is obtained, sufficiently hard to be able to be removed from the mould by disassembly of the mould system. The rate of conversion of the methacrylate functions, determined by infrared spectrometry, is greater than 95%.

### Transparency of the Organic Glasses:

In the manner described above a series of thermoset organic glasses is prepared, containing a fixed quantity of SBM triblock thermoplastic copolymer as mentioned above and increasing levels of the monofunctional acrylic comonomers according to the present invention (MMA and HEMA). The complementary part up to 100% is constituted by the formulation A defined above.

Table 1 shows the influence of the quantity of the acrylic comonomer on the transparency of the organic glasses obtained.

TABLE 1

| | | |
|---|---|---|
| Percentage by | | |
| weight of the | | |
| monofunctional | Hydroxymethyl | Methyl |
| acrylic | methacrylate | methacrylate |
| comonomer | (HEMA) | (MMA) |

| | |
|---|---|
| 0% | diffusing |
| 5% | diffusing |
| 10% | |
| 15% | transparent |
| 20% | |
| 25% | |

The minimum effective content of the comonomers MMA and HEMA is greater than 10% by weight.

Toughness

The toughness of certain formulations was evaluated by three-point bend fracture on notched samples.

Toughness Measurements

Criteria for linear elastic fracture mechanics

The linear elastic fracture mechanics apply to materials obeying Hooke's law (proportionality between applied stress and deformation) during stress of the notched sample (method 1, opening of the crack under tension, in our study). Within this framework, the measurement of two interdependent variables makes it possible to characterize the fracture mechanics:
G_{Ic}: energy at break (energy necessary to initiate crack propagation)
K_{Ic}: fracture toughness (resistance of the material to crack initiation) with G_{Ic}=K_{Ic}²/E in plane strain, and G_{Ic}=K_{Ic}²×(1−ν²)/E in plane deformation

Experimental Protocol:

The 3-point bend fracture tests were carried out on an Instron 4301 device (measured at 20° C.—air-conditioned room).

The geometry of the test pieces intended for the fracture tests is shown in FIG. 1. The test pieces were cut out, from discs 6 mm thick, with the dimensions recommended by Williams in his protocol (Williams J. G., EGF Task Group on Polymers and Composites, A Linear Elastic Fracture Mechanics (LEFM) standard for determining Kc and Gc for plastics (1989)). In a first phase, the test pieces were pre-notched using a cutter with a thickness of 0.5 mm, then annealed at 120° C. for 2 hours. Finally, an V-notch was produced with a razor blade at the bottom of the pre-notch, by means of a guillotine system.

The criteria relating to the geometry of the test pieces and the notching must be strictly adhered to, in order to test the sample under conditions of maximum fragility and to be able to apply the formulae producing K_{Ic} and G_{Ic}.

In our case, with reference to FIG. 1, B=6 mm, W=12 mm.

Calculation of the Fracture Variables

K_{Ic} is determined experimentally from the following formula:

K_{Ic}=f(α)×(Pₘₐₓ/BW^{1/2})

where B and W are respectively the thickness and the height of the sample.

a is the depth of the notch (notch+pre-notch).

Pₘₐₓ is the maximum force recorded during the breaking test.

α=a/W

f, for a sample of this geometry, is a geometric factor equal to:

$$f ( α ) = 6 {α}^{1 / 2} \frac{1.99 - α ( 1 - α ) ( 2.15 - 3.93 α + 2.7 {α}^{2} )}{( 1 - 2 α ) {( 1 - α )}^{3 / 2}}$$

G_{Ic} is determined experimentally by:

$${G}_{Ic} = \frac{{U}_{i}}{BW Φ ( α )}$$

where Uᵢ is the area under the force-displacement curve up to Pₘₐₓ and Φ is a geometric factor:

$$Φ ( α ) = \frac{Θ + 18.64}{\frac{d Θ}{d α}}$$

$$with$$

$$Θ ( α ) = \frac{16 {α}^{2}}{{( 1 - α )}^{2}} ( \begin{matrix}8.9 - 33.717 α + 79.616 {α}^{2} - \\ 112.952 {α}^{3} + 84.815 {α}^{4} - 25.672 {α}^{5}\end{matrix} )$$

$$\frac{d Θ}{d α} ( α ) = \frac{16 {α}^{2}}{{( 1 - α )}^{2}} ( \begin{matrix}- 33.717 + 159.2326 {α}^{2} - 338.856 {α}^{2} + \\ 339.26 {α}^{3} - 128.36 {α}^{4}\end{matrix} ) + \frac{32 α}{{( 1 - α )}^{3}} ( \begin{matrix}8.9 - 33.717 α + 79.616 {α}^{2} - \\ 112.952 {α}^{3} + 84.815 {α}^{4} - 25.672 {α}^{5}\end{matrix} )$$

Table 2 shows the critical stress intensity factor K_{IC} (expressed in MPa·m^{1/2}), the energy at break G_{Ic} (KJ/m²) and the modulus of elasticity E (MPa) of five samples of organic glasses, all perfectly transparent.

TABLE 2

| | | | E in |
|---|---|---|---|
| | K_{IC} (MPa · m^{1/2}) | G1c, (kJ/m²) | flexion (MPa) |
| Formulation A (100%) | 0.67 ± 0.01 | 0.21 ± 0.01 | 2382 |
| Formulation A/HEMA | 0.64 ± 0.04 | 0.21 ± 0.02 | 3100 |
| (78%/22%) | | | |
| Formulation | 1.08 ± 0.02 | 0.74 ± 0.01 | 2807 |
| A/HEMA/SBM | | | |
| (67.5%/25%/7.5%) | | | |
| Formulation A/MMA | 0.61 ± 0.03 | 0.19 ± 0.01 | 2434 |
| (78%/22%) | | | |
| Formulation | 1.29 ± 0.02 | 1.02 ± 0.02 | 2854 |
| A/MMA/SBM | | | |
| (67.5%/25%/7.5%) | | | |

The results demonstrate the effectiveness of the combined presence of SBM triblock copolymers and acrylic comonomer in the reinforcement of the mechanical properties of formulation A. In particular they show an increase in the energy G_{IC} restoration rate (0.74 and 1.02) relative to pure formulation A or in the presence only of an acrylic comonomer. The modulus of elasticity is also reinforced.

1. Method for the preparation of a transparent moulding comprising a blend of a thermoset polymeric material forming the matrix of said moulding, and of a thermoplastic polymeric material, dispersed within said thermoset polymeric material, said method comprising at least the following stages:
i) preparation of a liquid polymerizable mixture by dissolving said thermoplastic polymeric material in a thermosetting composition that is a precursor of said matrix,
ii) filling of a mould with the liquid polymerizable mixture prepared in stage i),
iii) polymerization of the liquid polymerizable mixture until a hardened blend of polymers is obtained, and
iv) removal of the moulding formed by said blend of polymers,
said process being characterized by the fact that the thermosetting composition comprises at least 60% by weight, preferably between 70 and 85% by weight of 4,4′-di(ethoxyethyl)-bisphenol A dimethacrylate of formula (I) 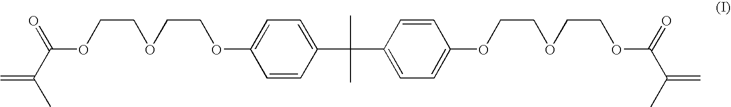
and at least 12% by weight, preferably 15% to 30% by weight, of at least one monofunctional or multifunctional acrylic comonomer and by the fact that the thermoplastic polymeric material comprises at least one polystyrene-block-polybutadiene-block-poly(methyl methacrylate) (PS-b-PB-b-PMMA) triblock copolymer.

2. Method for the preparation of a transparent moulding according to claim 1, characterized in that the acrylic comonomer is a monofunctional acrylic comonomer.

3. Method for the preparation of a transparent moulding according to claim 1, characterized in that the acrylic comonomer is chosen from methyl methacrylate, hydroxyethyl methacrylate, or a mixture thereof.

4. Method for the preparation of a transparent moulding according to claim 1, characterized in that the thermosetting composition represents 80 to 97% by weight, in particular 90 to 95% by weight of the mass of the polymerizable liquid mixture and in that the thermoplastic polymeric material represents 3 to 20% by weight, preferably 5 to 10% by weight of the polymerizable liquid mixture.

5. Method for the preparation of a transparent moulding according to claim 1, characterized in that the thermosetting composition also comprises at least one polymerization initiator, preferably at least one photoinitiator.

6. Method for the preparation of a transparent moulding according to claim 5, characterized in that the mass of the polymerization initiator or initiators represents 0.1 to 10% of the mass of the thermosetting polymerizable composition.

7. Method for the preparation of a transparent moulding according to claim 1, characterized in that the polymerizable liquid mixture is polymerized by photopolymerization.

8. Method for the preparation of a transparent moulding according to claim 1, characterized in that the polymerization in stage iii) is carried out at a temperature comprised between 0° C. and 100° C., preferably at a temperature comprised between 10 and 30° C., and in particular at a temperature comprised between 20 and 25° C.

9. Method for the preparation of a transparent moulding according to claim 1, characterized in that the poly(methyl methacrylate) (PMMA) block represents 50% to 80% by weight, preferably 52% to 70% by weight of the weight-average molar mass of the polystyrene-block-polybutadiene-block-poly(methyl methacrylate) triblock copolymer.

10. Method for the preparation of a transparent moulding according to claim 1, characterized in that the weight-average molar mass of said poly(methyl methacrylate) block is comprised between 10,000 and 100,000 g/mol.

11. Method for the preparation of a transparent moulding according to claim 1, characterized in that said transparent moulding is an optical article, preferably an ophthalmic lens.

12. Transparent moulding comprising a blend of a thermoset polymer and of a triblock thermoplastic polymer, obtainable by a method according to claim 1.

13. Transparent moulding according to claim 12, characterized by the fait that it is an ophthalmic lens.

14. Polymerizable liquid mixture comprising a thermoplastic polymeric material dissolved in a thermosetting composition, characterized by the fact that the thermosetting composition comprises at least 60% by weight, preferably between 70 and 85% by weight of 4,4′-di(ethoxyethoxy)-bisphenol A dimethacrylate of formula (I) 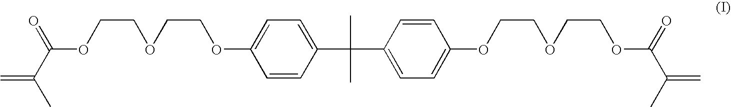
and at least 12% by weight, preferably 15% to 30% by weight, of at least one monofunctional or multifunctional acrylic comonomer, and by the fact that the thermoplastic polymeric material comprises at least one polystyrene-block-polybutadiene-block-poly(methyl methacrylate) (PS-b-PB-b-PMMA) triblock copolymer.

15. Polymerizable liquid mixture according to claim 14, characterized in that the acrylic comonomer is a monofunctional acrylic comonomer.

16. Polymerizable liquid mixture according to claim 14, characterized in that the acrylic comonomer is chosen from methyl methacrylate, hydroxyethyl methacrylate, or a mixture thereof.

17. Polymerizable liquid mixture according to claim 14, characterized in that the thermosetting composition represents 80 to 97% by weight, preferably 90 to 95% by weight of the mass of the polymerizable liquid mixture and in that the thermoplastic polymeric material represents 3 to 20% by weight, preferably 5 to 10% by weight of the polymerizable liquid mixture.

18. Polymerizable liquid mixture according to claim 14, characterized in that the thermosetting composition also comprises at least one polymerization initiator, preferably at least one photoinitiator.

19. Polymerizable liquid mixture according to claim 14, characterized in that the mass of the polymerization initiator or initiators represents 0.1 to 10% of the mass of the thermosetting polymerizable composition.

20. Polymerizable liquid mixture according to claim 14, characterized in that the poly(methyl methacrylate) (PMMA) block represents 50% to 80% by weight, preferably 52% to 70% by weight of the weight-average molar mass of the polystyrene-block-polybutadiene-block-poly(methyl methacrylate) triblock copolymer.
